(19) United States
(12) Patent Application Publication
(10) Pub. No.: US 2002/0048334 A1
(43) Pub. Date: Apr. 25, 2002

(54) Bit allocation method and apparatus therefor

(76) Inventor: Kazutomo Hasegawa, kawasaki (JP)

Correspondence Address: ROSENMAN & COLIN LLP, 575 MADISON AVENUE, NEW YORK, NY, 10022-2585, US

(21) Appl. No.: 09/804,520

(22) Filed: Mar. 12, 2001

(30) Foreign Application Priority Data
Oct. 19, 2000 (JP) 2000-319043

(51) Int. Cl. H04L 27/28

(52) U.S. Cl. 375/360

(57) ABSTRACT

When the number of transmit bits and gain allocated to each carrier of a multicarrier transmission system are decided, the S/N ratio of each carrier is found and a number of transmit bits is allocated to each of the carriers based upon the respective S/N ratios thereof. Next, the gains of carriers for which the number of allocated bits is equal to a maximum limit number are decreased and the gains of prescribed carriers other than these carriers are increased. Control is performed in such a manner that the sum total of gain increases and sum total of gain decreases will be equal, as a result of which the total of number of transmit bits allocated to the carriers is increased.

### BACKGROUND OF THE INVENTION

This invention relates to a bit allocation method and apparatus and, more particularly, to a bit allocation method and apparatus for deciding the number of bits and gain to be allocated to each carrier in multicarrier transmission.

Multimedia services such as the Internet have become widespread throughout society inclusive of the ordinary home and there is increasing demand for early provision of economical, highly reliable digital subscriber line transmission systems and apparatus for utilizing these services.

Enormous expenditures of money and time are required to lay new communication lines. For this reason, a digital subscriber line transmission system in which existing communication lines are utilized to communicate data at high speed. A known example of a technique for providing a digital subscriber line transmission system is xDSL (Digital Subscriber Line). xDSL is a transmission scheme that utilizes a telephone line and is one modulation/demodulation technique. xDSL is broadly divided into symmetric xDSL and asymmetric xDSL. In symmetric xDSL, the upstream transmission rate from the subscriber residence (referred to as the “subscriber•side” below) to the accommodating office (referred to as the “office side” below) and the downstream transmission rate from the office side to the subscriber side are symmetrical; in asymmetric xDSL, the upstream and downstream transmission rates are asymmetrical. An example of asymmetric xDSL is ADSL (Asymmetric DSL), and examples of symmetric xDSL are HDSL (High-bit-rate DSL) and SHDSL (Single-pair High-bit-rate DSL). With ADSL, downstream transmission rates are on the order of several Mbps and upstream transmission rates are on the order of several hundred kbps. DMT (Discrete Multiple Tone) modulation is standardized as the modulation scheme by ITU-T recommendations.

DMT Modulation

DMT modulation will be described with regard to modulation/demodulation in the downstream direction from the office side to the subscriber side.

With DMT modulation, as shown in FIG. 12, a frequency band of 1.104 MHz is divided into N-number (255) of multicarriers #1˜#255 at intervals of Δf (=4.3125 KHz). In training carried out before communication, the S/N ratios of the respective carriers #1˜#255 are measured and it is decided, depending upon the S/N ratios, with which modulation method among 4-QAM, 16-QAM, 64-QAM, 128-QAM . . . modulation methods data is to be transmitted over each carrier. For example, 4-QAM is assigned to a carrier having a small S/N ratio and 16-QAM, 64-QAM, 128-QAM . . . are assigned successively as the S/N ratio increases. It should be noted that 4-QAM is a modulation scheme in which two bits are transmitted at a time, 16-QAM a modulation scheme in which four bits are transmitted at a time, 64-QAM a modulation scheme in which six bits are transmitted at a time, and 128-QAM a modulation scheme in which seven bits are transmitted at a time. Among schemes in which signals are transmitted simultaneously in upstream and downstream directions, a frequency-division transmission scheme uses carriers #1˜#31 of the 255 carriers for the upstream direction from the subscriber side to the office side, and uses carriers #33˜#255 for the downstream direction from the office side to the subscriber side.

FIG. 13 is a diagram useful in describing 16-QAM. Here a serial/parallel converter (S/P converter) 1 stores transmit data, which enters as a bit serial, in a buffer successively four bits at a time and outputs four bits as 2-bit parallel data (aᵢ,bᵢ), (aᵢ₊₁,bᵢ₊₁). A first binary/quaternary converter 2 converts the parallel data (aᵢ,bᵢ) to four values (−3, −1, +1, +3), and a second binary/quaternary converter 3 converts the parallel data (aᵢ₊₁,bᵢ₊₁) to four values (−3, −1, +1, +3). A carrier generator 4 generates a cosine wave cos (ω_{c}t) of frequency f_{c} (ω_{c}=2πf_{c}), and a phase shifter 5 shifts the phase of the cosine wave by 90° to output a sine wave sin (ω_{c}t). An AM modulator 6 multiplies the output of the first binary/quaternary converter 2 by the sine wave sin (ω_{c}t), and an AM modulator 7 multiplies the output of the second binary/quaternary converter 3 by the cosine wave cos (ω_{c}t). An adder 8 combines the outputs of the AM modulators 6 and 7 and outputs the combined signal. By executing the operation described above, the 16-QAM modulator outputs signals having the illustrated two-dimensional signal point placement (constellation) in accordance with the combination of parallel data (aᵢ,bᵢ), (aᵢ₊₁,bᵢ₊₁). For example, if data divided into four bits at a time is 1001, 0011, 1100, 0110, the 16-QAM modulator outputs signals (1)→(2)→(3)→(4) in the constellation.

FIG. 14 is diagram useful in describing the principle of DMT modulation. Bit-serial transmit data enters an S/P converter 11. From this transmit data, a bit sequence that is to be transmitted within a certain period is stored in an internal buffer of the S/P converter 11 and subsequently is output to a carrier mapper 12. Data transmitted within this fixed period is referred to as a symbol. Since the QAM modulation scheme of each carrier is known, the carrier mapper 12 divides the one symbol's worth of bit sequence bₖ-number of bits at a time in accordance with the QAM modulation scheme of each carrier and inputs the resultant bit sequence QAM modulator 13i of the particular carrier. As a result, the total number of output bits per symbol is Σbₖ (k=1 to N). A frequency multiplexer 14 frequency multiplexes the QAM signals output from the QAM modulators 13i of the respective carriers and outputs the multiplexed signal to a transmission line via a transmission-line drive circuit (not shown).

Here the frequency multiplexer 14 is provided with an arithmetic unit for implementing an IFFT (Inverse Fast-Fourier Transform), whereby transmission based upon DMT modulation is carried out.

FIG. 15 is a functional block diagram of a subscriber line transmission system based upon DMT modulation. Entered transmit data addressed to a subscriber is stored in an amount conforming to the time for one symbol (=1/4000 s) in a serial-parallel conversion buffer (Serial-to-Parallel Buffer) 10. The stored data is divided into transmit bit counts per carrier decided by training in advance and saved in a transmit B&G controller 60. The data is then input to an encoder 20. More specifically, since the QAM modulation scheme of each carrier is known from training, one symbol's worth of a bit sequence is divided bₖ bits at a time, where the bit count bₖ conforms to the QAM modulation scheme of each carrier, and the bits are input to the encoder 20. As a result, the total number of output bits per symbol is Σbₖ (k=1˜N). The encoder 20 converts each input bit sequence bₖ to signal-point data (signal-point data on a constellation diagram) for performing quadrature amplitude modulation (QAM) and inputs the converted data to an Inverse Fast-Fourier Transform (IFFT) unit 30. The IFFT unit 30 applies quadrature amplitude modulation to each signal point by performing an IFFT operation and inputs the processed data to a parallel-to-serial conversion buffer (Parallel-to-Serial Buffer) 40. Here a total of 32 samples, namely IFFT output samples 480˜511, are attached to the beginning of a DMT signal as a cyclic prefix. The parallel-to-serial conversion buffer 40 inputs 512+32 items of sample data to a D/A converter 50 successively in serial fashion. The D/A converter 50 converts the input digital data to an analog signal at a sampling frequency of 2.208 MHz and sends the analog signal to the subscriber side via a metallic line 70.

On the subscriber side, an A/D converter 80 converts the input analog signal to a 2.208-MHz digital signal and inputs the digital signal to a time domain equalizer (TEQ) 90. The latter applies processing to the input digital data in such a manner that inter-symbol interference (ISI) will fall within the cyclic prefix of 32 symbols, and inputs the processed data to a serial-to-parallel conversion buffer 100. The latter stores one DMT symbol's worth of data and subsequently removes the cyclic prefix and inputs one DMT symbol's worth of data to a fast-Fourier transform (FFT) unit 110 simultaneously in parallel fashion. The FFT unit 110 implements a fast-Fourier transform and generates (demodulates) 255 signal points. A frequency domain equalizer (FEQ) 120 subjects the demodulated 255 items of signal-point data to inter-channel interference (ICI) compensation. A decoder 130 decodes the 255 items of signal-point data in accordance with a receive B&G controller 150, which has values identical with those of the transmit B&G controller 60, and stores the data obtained by decoding in a parallel-to-serial conversion buffer 140. The data is subsequently read out of this buffer in the form of a bit serial. This data constitutes the receive data.

The details of the above-described multicarrier transmission system are disclosed in John A. C. Bingham, “Multicarrier Modulation for Data Transmission: An Idea Whose Time Has Come”, IEEE Communications Magazine, Volume 28, Number 5, pp. 5˜14, May 1990.

Setting of Allocated Bits

The number of bits allocated to each carrier is decided on the receiving side. Specifically, the number of allocated bits for an upstream signal is decided on the office side and the number of allocated bits for a downstream signal is decided on the subscriber side. When training is performed, ADSL units on the office and subscriber sides decide the allocated bits in accordance with a protocol referred to as B&G (bit and gain).

FIG. 16 is a diagram useful in describing an overview of the B&G protocol for the downstream direction. (1) When training is performed, the ADSL units recognize each other and then the ADSL unit ATU-C on the office side sends several frequency signals to the opposing ADSL unit ATU-R on the subscriber side. (2) The ADSL unit ATU-R on the subscriber side calculates the S/N ratio of each carrier. (3) Next, the ADSL unit ATU-R on the subscriber side decides the allocated bits of each carrier based upon the calculated S/N ratio of each carrier and reports the allocated bits and transmission level (gain) to the ADSL unit ATU-C on the office side. (4) The ADSL unit ATU-C on the office side performs DMT modulation based upon the reported allocated bits and transmission-level information and transmits the resultant data.

An example of a method of setting an allocation table indicative of the number of allocated bits and gain of each carrier is disclosed in Peter S. Chow, John M. Cioffi, “Method and apparatus for adaptive, variable bandwidth, high-speed data transmission of a multicarrier signal over digital subscriber lines”, U.S. Pat. No. 5,479,447. The theory on which this is based will now be described in simple terms.

FIG. 17 illustrates the relationship between an S/N-ratio curve (S/N curve), which indicates the ratio of the size of a receive signal for each frequency to the magnitude of noise inflicted upon this receive signal, and number of bits allocated to each carrier. If the S/N ratio at the time of frequency n·f_{d} is SNRₙ for a carrier #n whose frequency is n·f_{d}, the optimum number bₙ of bits to allocated to the carrier #n is calculated in accordance with the following equation:

bₙ=log₂(1+SNRₙ/Γ) (1)

where n represents a positive integer that is equal to or less than N and f_{d} represents carrier spacing. In the example of FIG. 12, N=255 and f_{d}=4.3125 kHz hold. Further, Γ represents SNR gap.

The optimum number bₙ of bits in many cases is a decimal number, as indicated by the dashed line in FIG. 17. For example, if the S/N ratio SNR6 of carrier #6 (=frequency 6·f_{d}) is inserted into Equation (1), the optimum bit count b₆ is about 4.2, which is a decimal. However, the number of bits actually allocated to each carrier can take on only an integral value. Accordingly, the values indicated by the solid line obtained by discarding the decimal part of the calculated values become the numbers of bits actually allocated to the carriers. In the above-mentioned example, four bits, which is the number obtained by discarding the decimal part of 4.2, are allocated to carrier #6. Similarly, bits are allocated to the other carriers upon discarding decimals so that the relationship between carriers and numbers of allocated bits becomes as shown in FIG. 18. It should be noted that when the optimum bit count calculated in accordance with Equation (1) is equal to or greater than 1.0 and less than 2.0, at present not even one bit is allocated, as indicated by FIG. 17. If the maximum limit on allocated bits is five, then, even in a case where the optimum allocated bit count indicated by the dashed line in FIG. 17 is six or greater, the number of bits allocated is limited to five, as shown by the solid line in FIG. 17.

In the example set forth above, the number of bits actually allocated to each carrier is decided upon discarding the decimal part. However, a method that utilizes a calculated bit count without discarding the decimal part also is available. For example, in a case where the optimum bit count b₆ is calculated to be about 4.2 in accordance with Equation (1), this method finds a power Δx necessary to obtain a total bit count of five by allocating 0.8 bits, stores the power Δx and the allocated bit count (five in this example), which is based upon the power increase, in the receive B&G controller 150 and simultaneously notifies the transmit B&G controller 60 on the transmitting side. It should be noted that if the original power is made 1 by normalization, then changing power by ±Δx is the same as making the additional gain ±Δx.

In actuality, when training is performed prior to data communication, the content of an updated receive allocation table is reported from the receiving side to the transmitting side and the bit allocation table of the transmit B&G controller on the transmitting side is updated so as to make its content identical with that of the bit allocation table on the receiving side. Data is transmitted on the transmitting side based upon the updated information in the bit allocation table. In this example, transmission with regard to carrier #6 is performed using five bits as the number of allocated bits and Δx as the additional gain. In a case where the additional gain of a carrier is varied and made Δx, the additional gain of another carrier is made −Δx so that the total additional gain of all carriers will be zero. This is because it is necessary to make transmission power uniform for use in linear characteristic components.

With conventional bit allocation, as described above, how much additional gain is necessary to increase the allocation of one bit is calculated from the S/N ratio at the output of the FEQ 120, and the number of allocated bits is calculated in accordance with Equation (1) taking this additional gain into consideration. Though this method does make it possible to obtain a favorable bit allocation by calculating the optimum additional gain, the process through which the optimum additional gain is calculated is complicated and the optimum additional gain and bit allocation cannot be acquired in a short period of time. Thus there is sought a bit allocation method and apparatus through which the optimum additional gain and bit allocation can be calculated in a short time by simplifying the process for finding the additional gain.

### SUMMARY OF THE INVENTION

Accordingly, an object of the present invention make it possible to calculate optimum additional gain and bit allocation in a short time.

Another object of the present invention is to make it possible to increase the total number of transmitted bits allocated to the carriers without raising transmission power, thereby improving the transmission capability of a multicarrier transmission apparatus.

A first bit allocation method according to the present invention (1) measures the SIN ratio of each carrier and allocates a number of transmit bits to each carrier based upon the S/N ratio; (2) subsequently decreases the gains of carriers for which the number of allocated bits is equal to a maximum limit number and increases the gains of prescribed carriers other than these carriers; and (3) performs control in such a manner that the sum total of gain increases and the sum total of gain decreases will be equal, wherein the total of number of transmit bits allocated to the carriers is increased.

Though the number of bits allocated to each carrier is decided in dependence upon the S/N ratio of the carrier, the number of allocated bits cannot be increased beyond a maximum limit number regardless of how good the S/N ratio becomes. In other words, a carrier to which the maximum limit number has been allocated has some surplus in terms of gain. Hence, if the surplus gain can be decreased and the gains of other carriers increased, then the total number of allocated bits can be increased. The present invention takes note of this and is capable of increasing the total of number of transmit bits allocated to the carriers without raising transmission power, thereby making it possible to improve the transmission capability of a multicarrier transmission apparatus.

In this case, a carrier for which gain is increased is made a carrier for which the number of allocated bits is large. This is because the number of bits can be increased by one with a power that is lower for a carrier for which the number of allocated bits is large than for a carrier for which the number of allocated bits is small.

A second bit allocation method according to the present invention (1) measures the S/N ratio of each carrier and allocates a number of transmit bits to each carrier based upon the S/N ratio; (2) subsequently increases the gains of carriers, among carriers to which bits have not been allocated, for which there is a high likelihood that bits will be allocated anew if the gains thereof are increased, and decreases the gains of prescribed carriers other than these carriers; and (3) performs control in such a manner that the sum total of gain increases and the sum total of gain decreases will be equal, wherein the total number of transmit bits allocated to the carriers is increased.

Even if a carrier is one to which even one transmit bit has not been allocated due to an inadequate S/N ratio, it becomes possible to transmit two bits at a stroke if gain is increased (because 1-bit QAM modulation does not exist). Accordingly, if the gain of a carrier to which transmit bits have not been allocated is increased and the gains of other carriers are decreased, the total number of allocated bits can be increased. The present invention takes note of this and is capable of increasing the total number transmit bits allocated to the carriers without raising transmission power, thereby making it possible to improve the transmission capability of a multicarrier transmission apparatus.

In this case, a carrier for which gain is decreased is made a carrier for which the number of allocated bits is small but other than two. This is because there are cases where if the gain of a carrier for which the number of allocated bits is two is decreased, the number of allocated bits changes from two to zero owing to the decrease in gain. Further, the number of allocated bits can be decreased by one with a power that is larger for a carrier for which the number of allocated bits is small than for a carrier for which the number of allocated bits is large.

A third bit allocation method according to the present invention (1) measures the S/N ratio of each carrier and allocates a number of transmit bits to each carrier based upon the S/N ratio; (2) subsequently decreases the gains of carriers, among carriers to which bits have not been allocated, for which there is little likelihood that bits will be allocated anew even if the gains thereof are increased, and increases the gains of prescribed carriers other than these carriers; and (3) performs control in such a manner that the sum total of gain increases and the sum total of gain decreases will be equal, wherein the total number of transmit bits allocated to the carriers is increased.

A carrier to which a transmit bit has not been allocated due to an inadequate S/N ratio and which is not likely to be allocated a bit anew even if gain is increased is a carrier that is useless. Accordingly, if a reduction is made in the gains of carriers, among carriers to which bits have not been allocated, for which there is little likelihood that bits will be allocated anew even if the gains thereof are increased, and if the gains of prescribed carriers other than these carriers are increased, then the total number of allocated bits can be increased. The present invention takes note of this and is capable of increasing the total number of transmit bits allocated to the carriers without raising transmission power, thereby making it possible to improve the transmission capability of a multicarrier transmission apparatus.

In this case, a carrier for which gain is increased is a prescribed carrier other than a carrier for which the number of allocated bits is equal to the maximum limit number. This is because even if the gain of a carrier for which the number of allocated bits is equal to the maximum limit number is increased, the number of allocated bits does not increase.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the configuration of a subscriber line transmission system based upon DMT modulation according to the present invention;

FIG. 2 shows an algorithm of a first bit allocation method according to the present invention;

FIG. 3 is a diagram useful in describing the first bit allocation method according to the present invention;

FIG. 4 is a table useful in describing number of allocated bits according to the first bit allocation method of the present invention;

FIG. 5 is a flowchart of bit allocation processing at the time of training;

FIG. 6 shows an algorithm of a second bit allocation method according to the present invention;

FIG. 7 is a diagram useful in describing the second bit allocation method according to the present invention;

FIG. 8 is a table useful in describing number of allocated bits according to the second bit allocation method of the present invention;

FIG. 9 shows an algorithm of a third bit allocation method according to the present invention;

FIG. 10 is a diagram useful in describing the third bit allocation method according to the present invention;

FIG. 11 is a table useful in describing number of allocated bits according to the third bit allocation method of the present invention;

FIG. 12 is a diagram useful in describing a DMT transmission spectrum according to the prior art;

FIG. 13 is a diagram useful in describing 16-QAM according to the prior art;

FIG. 14 is a diagram useful in describing the principle of DMT modulation according to the prior art;

FIG. 15 is a functional diagram of a subscriber transmission system which relies upon DMT modulation according to the prior art;

FIG. 16 is a diagram useful in describing a B&G protocol according to the prior art;

FIG. 17 is a diagram useful in describing the relationship among S/N ratio, optimum number of bits and actual allocated number of bits according to the prior art; and

FIG. 18 is a table showing the relationship between carriers and numbers of allocated bits according to the prior art.

### DESCRIPTION OF THE PREFERRED EMBODIMENTS

(A) Configuration

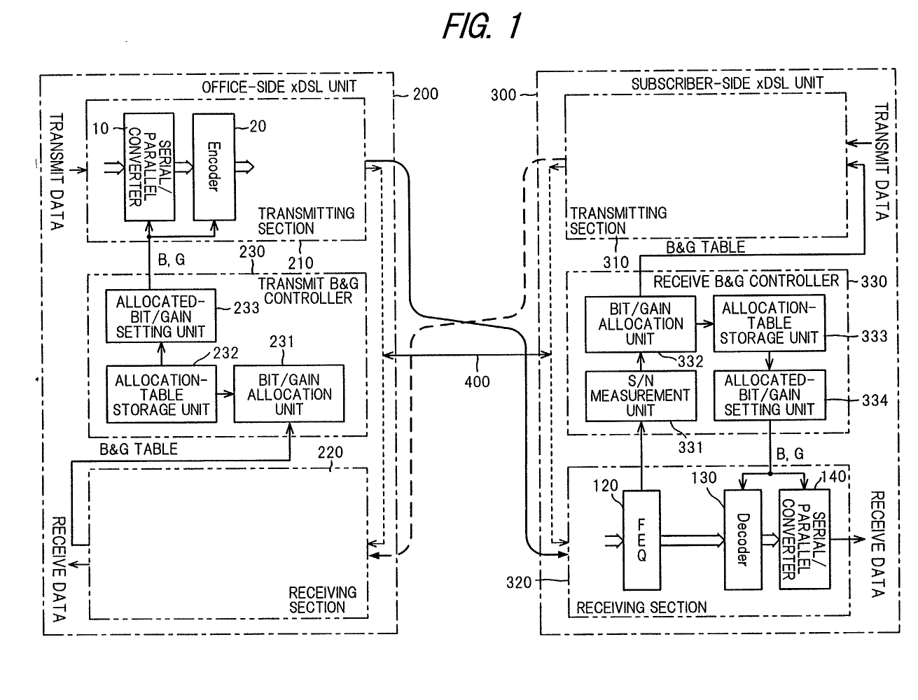

FIG. 1 is a block diagram illustrating the configuration of a subscriber line transmission system based upon DMT modulation according to the present invention. An xDSL unit 200 on the office side and an xDSL on the subscriber side are connected for bidirectional communication by a telephone line (metallic line) 400.

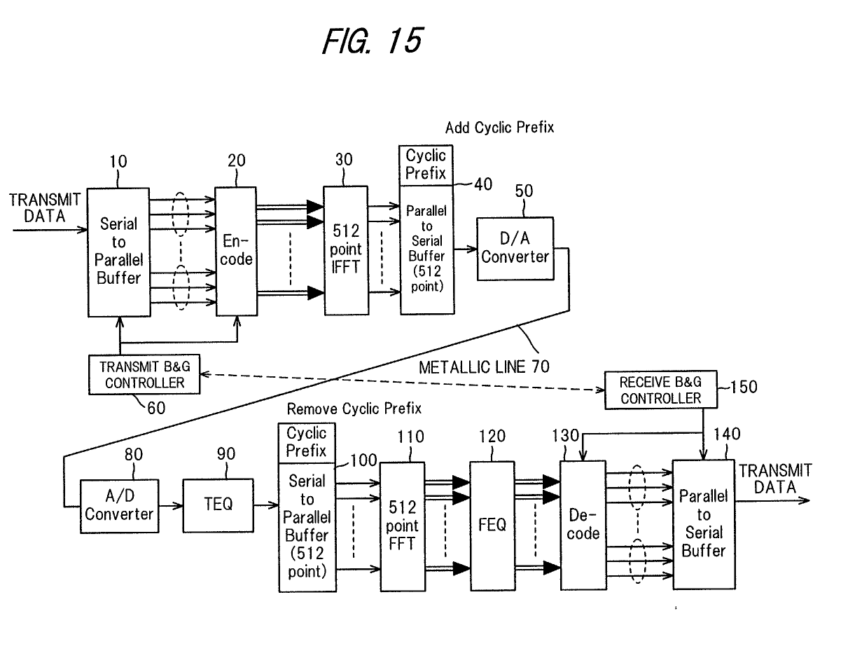

The office-side xDSL unit 200 and the subscriber-side xDSL unit 300 have transmitting sections 210, 310, respectively, each of which has components identical with the components 10 to 50 on the transmitting side shown in FIG. 15, and receiving sections 220, 320, respectively, each of which has components identical with the components 80 to 140 on the receiving side shown in FIG. 15. The office-side xDSL unit 200 further includes a transmit B&G controller 230 corresponding to the transmit B&G controller 60 of FIG. 15, and the subscriber-side xDSL unit 300 further includes a receive B&G controller 330 corresponding to the receive B&G controller 150 of FIG. 15.

Only components for implementing a B&G protocol in the downstream direction are illustrated for the transmit B&G controller 230 and receive B&G controller 330; components for implementing a B&G protocol in the upstream direction are not shown. However, the components for implementing the B&G protocol in the upstream direction are similar to those for implementing the B&G protocol in the downstream direction and portions that can be shared are shared.

The transmit B&G controller 230 has a bit/gain allocation unit 231 for storing a bit allocation table sent from the receive B&G controller 330 and allocating a bit count B and gain G to each carrier; an allocation-table storage unit 232 for storing a bit allocation table; and a bit/gain setting unit 233 for setting the allocated bit count B and gain G in the serial/parallel converter 10 and encoder 20 on a per-carrier basis.

The receive B&G controller 330 includes an S/N measurement unit 331 for measuring the S/N ratio of each carrier based upon the output of the FEQ 120; a bit/gain allocation unit 332 for allocating bit/gain to each carrier based upon the S/N ratio of each carrier; an allocation-table storage unit 333 for storing a correspondence table (bit allocation table) indicating the correspondence between carriers and bit/gain allocated thereto; and an allocated-bit/gain setting unit 334 for setting an allocated bit count B and gain G in the decoder 130 and parallel/serial converter 140 of the receiving section 320. It should be noted that the bit/gain allocation unit 332 sends the generated bit allocation table to the transmit B&G controller 230 via the transmitting section 310, metallic line 400 and receiving section 220 in the order mentioned.

(B) First Allocation Method

The number of bits allocated to each carrier in multicarrier transmission is decided in accordance with the S/N ratio. However, the number of allocated bits cannot be increased beyond a maximum limit number regardless of how good the S/N ratio becomes. In other words, a carrier to which the maximum limit number has been allocated has gain to spare. Accordingly, if surplus gain of this carrier is decreased and the gains of other carriers increased, then the total number of allocated bits can be increased. This idea forms the basis of the present invention.

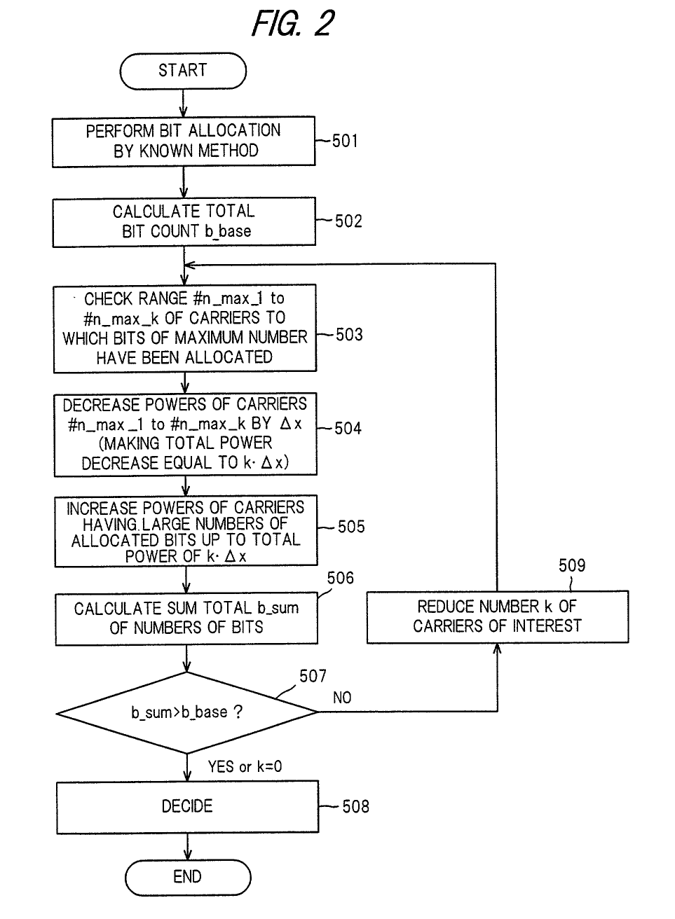

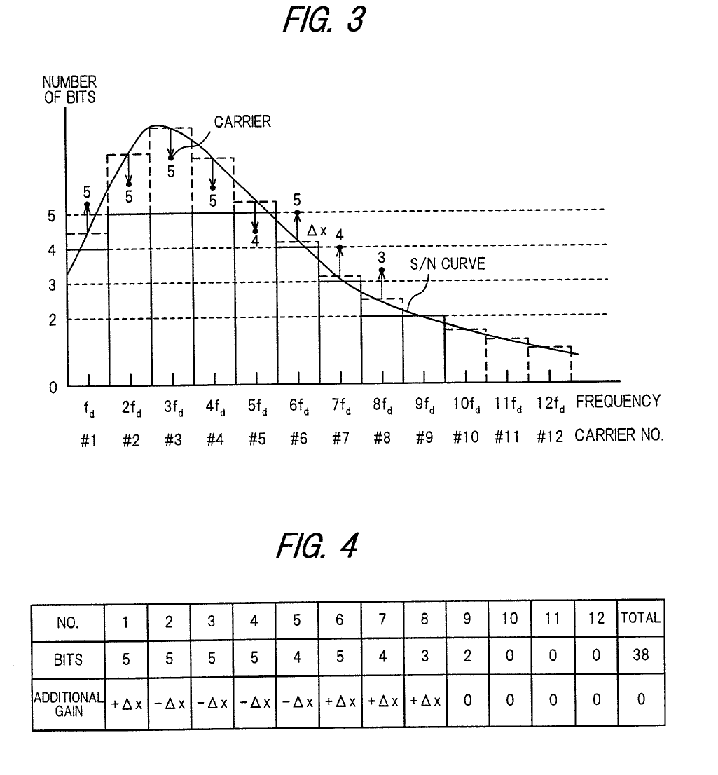

FIG. 2 shows the algorithm of a first bit allocation method implemented by the receive B&G controller 330 according to the present invention, and FIG. 3 is a diagram useful in describing the first bit allocation method.

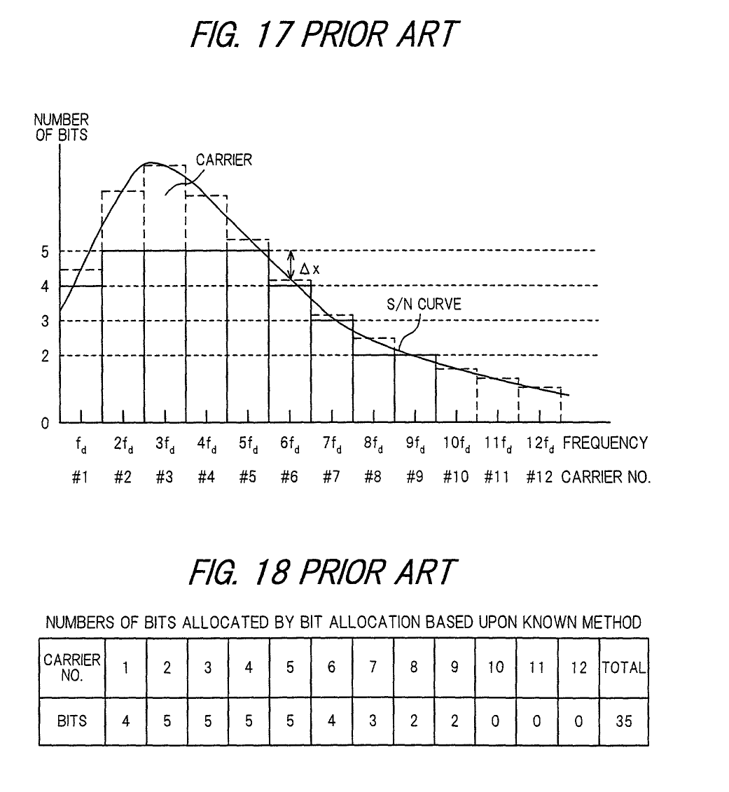

First, bit allocation based upon a well-known method is carried out (step 501) and then the total bit count b_base, namely the total number of bits, that has been allocated to all carriers is calculated (step 502). With reference to FIG. 3, the bit/gain allocation unit 332 decides an optimum allocated bit count bn (see the dashed line in FIG. 3) in accordance with Equation (1) based upon the S/N ratio curve obtained by the S/N measurement unit 331. The solid line, which is obtained by discarding the decimal part of the optimum allocated bit count indicated by the dashed line, becomes the number of bits allocated by the already known bit allocation method. It should be noted that if the maximum limit on number of allocated bits is five, the number of bits actually allocated is restricted to five even in a case where optimum number of allocated bits indicated by the dashed line is 6.0 or greater. In accordance with the already known bit allocation method set forth above, bits are allocated to each of the carriers #1 to #12 and b_base is equal to 35, as illustrated in FIGS. 17 and 18 indicative of the prior art.

When the calculation of total bit count b_base at step 502 is completed, the bit/gain allocation unit 332 checks the range #n_max_{—}1 to #n_max_k of carriers to which bits of the maximum limit number (=5) have been allocated (step 503). In FIG. 3, the range of carriers to which the maximum limit number of bits have been allocated is #2 to #5, and k=4 holds.

Next, the powers of the carriers #n_max_1 to #n_max_k (carriers #2 to #5) are decreased by Δx (for a total power reduction of k·Δx) (step 504), and the powers of the plurality of carriers having large numbers of allocated bits, which carriers are other than the carriers #n_max_{—}1 to #n_max_k (carriers #2 to #5), are increased up to a total power of k·Δx (step 505). The reason for adopting carriers having large numbers of allocated bits as the carriers for which power is increased is that when the power for increasing the number of allocated bits by one bit is taken into account, the increase of one bit can be achieved with less power in the case of carriers for which the number of allocated bits is large. It should be noted that if the original power is made 1 by normalization, then increasing or decreasing power by ±Δx is equivalent to changing gain by ±Δx.

After the power of each carrier is increased or decreased, the number of allocated bits of each carrier is calculated in accordance with Equation (1) and the sum total b_sum of numbers of bits obtained when the decimal parts of the bit counts are discarded is calculated (step 506). This is illustrated by the combinations of arrows and black dots in FIG. 3. The powers of carriers #2 to #5 are decreased by Δx each (for a total decrease of 4·Δx), and the powers of carriers #1, #6, #7, #8 are increased correspondingly by Δx each. In the case of FIG. 3, the number of bits allocated to each carrier becomes as shown in FIG. 4, and b_sum is equal to 38. It should be noted that an arrangement may be adopted in which the powers of any three carriers are increased for a total increase of 4·Δx rather than increasing the powers of the carriers #1, #6, #7, #8 by Δx each.

Next, the total bit count b_base obtained by the known method and the total allocated bit count b_sum after the power increase/decrease are compared in terms of magnitude (step 507). If b_sum>b_base holds or k=0 holds, first bit allocation processing of the present invention is exited (step 508). That is, the bit/gain allocation unit 332 creates an allocation table (see FIG. 4), which includes the number B of bits allocated to each carrier and the additional gain G of each carrier, stores this table in the allocation-table storage unit 333 and then sends the table to the office side from the transmitting section 310.

If it is found that b_sum≦b_base holds (“NO” at step 507), k is reduced (step 509) and the processing from step 503 onward is repeated. In the example of FIG. 4, the carriers of interest are carriers #2 to #5 (k=4) and therefore the number of carriers of interest may be reduced from the high-frequency end, as in the manner #3 to #5 (k=3) or from the low-frequency end, as in the manner #2 to #4 (k=3), by way of example. Then b_sum is obtained again and processing continues until a “YES” decision is rendered at step 507. However, if k=0 is found to hold at step 507, processing is terminated, even if a “YES” decision is not obtained, and bits are allocated in accordance with bit allocation by the known method (where the total number of bits is b_base). Furthermore, even in a case where a “YES” decision is rendered at step 507 of FIG. 2 and processing would ordinarily be exited, the number k of carriers of interest may be reduced if desired to search for the optimum bit allocation.

Thus, in accordance with the first bit allocation method of the present invention, the total number of transmit bits allocated to carriers can be increased without raising total transmission power, thereby making it possible to improve the transmission capability of a multicarrier transmission apparatus.

Modification

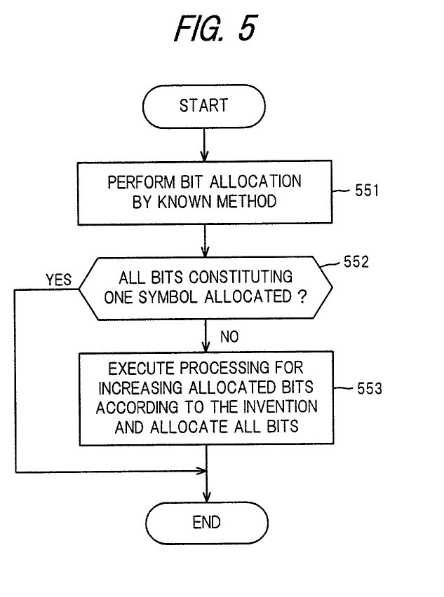

The present invention as set forth above is applied to a case where the transmission capability of a multicarrier transmission apparatus is to be improved. However, the invention can be applied also to bit allocation processing carried out at training of a subscriber line transmission system. FIG. 5 is a flowchart of bit allocation processing executed at the time of training in accordance with the present invention.

In a subscriber line transmission system that relies upon DMT modulation, one symbol period is 1/4000 s (=250 μs) and the symbol is composed of M bits. Accordingly, it is necessary to subject M bits to multicarrier transmission in one symbol period.

At training time, therefore, bit allocation is performed by the known allocation method (step 551) and it is determined whether the allocation of M bits has been achieved (step 552). If M bits could be allocated (“YES” at step 552), bit allocation processing is exited. If M bits could not be allocated (“NO” at step 552), however, then M bits are allocated upon increasing the number of allocated bits by executing processing from step 502 onward in the bit allocation algorithm of FIG. 2 (step 553).

(C) Second Allocation Method

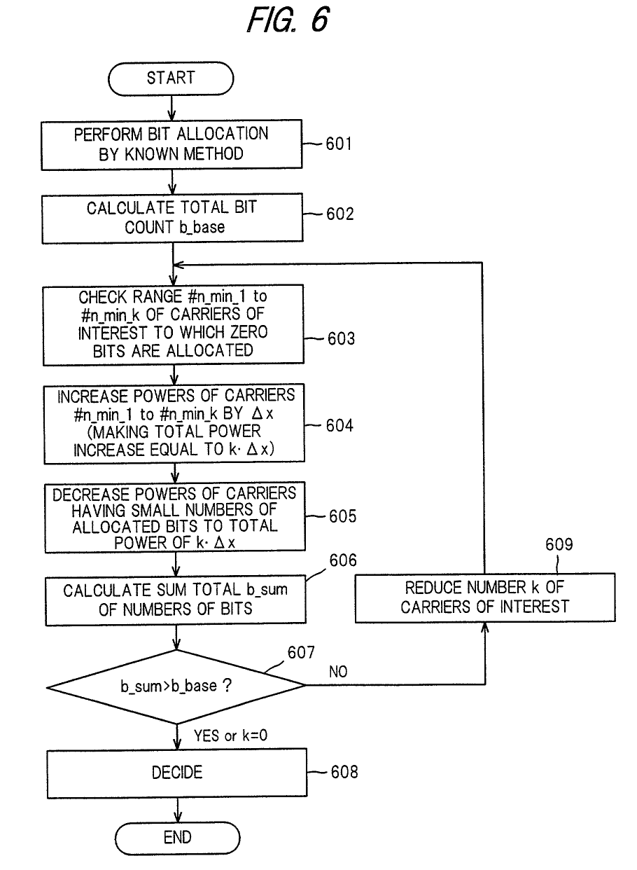

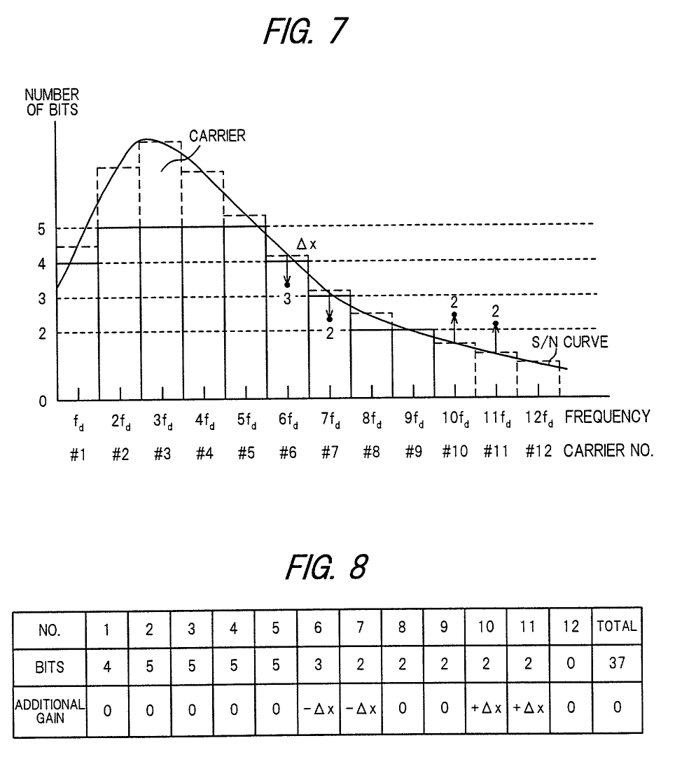

FIG. 6 shows the algorithm of a second bit allocation method implemented by the receive B&G controller 330 according to the present invention, and FIG. 7 is a diagram useful in describing the second bit allocation method.

First, bit allocation based upon a well-known method is carried out (step 601) and then the total bit count b_base, namely the total number of bits, that has been allocated to all carriers is calculated (step 602). The example of FIG. 7 is similar to that of the example of FIG. 3 and the details thereof need not be described again. The result of this processing is that bits are allocated to each of the carriers #1 to #12 and b_base becomes equal to 35, as illustrated in FIG. 17.

When the calculation of total bit count b_base at step 602 is completed, the range #n_min_{—}1 to #n_min_k of carriers of interest to which zero bits are allocated is checked (step 603).

A carrier of interest to which no bits are allocated is a carrier, among carriers for which the bit allocation is zero, for which there is a high likelihood that a bit will be allocated anew by an increase in power. In actuality, the higher the frequency, the lower the S/N curve, as illustrated in FIG. 7. This means that the higher the frequency of the carrier, the greater the possibility that a bit will not be allocated to the carrier. Accordingly, there are many cases where several carriers on the high-frequency side of the carrier of maximum frequency to which bits have been allocated become the carrier range of interest. In FIG. 7, bits have been allocated up to carrier #9; hence, carriers #10 to #11 on the side of higher frequency constitute the range of carriers of interest. In this case, k=2 holds.

Next, the powers of the carriers #n_min_{—}1 to #n_min_k (carriers #10 to #11) are increased by Δx (for a total power increase of k·Δx) (step 604), and the powers of carriers having numbers of allocated bits that are as small as possible, which carriers are other than the carriers #n_min_{—}1 to #n_min_k (carriers #10 to #11), are decreased to a total power of k·Δx (step 605). It is assumed here that the carriers for which power is decreased do not include carriers #8 to #9 to each of which two bits have been allocated. The reason for this is that if the power of a carrier for which the number of allocated bits is two is reduced, the number of allocated bits may change from two to zero. Accordingly, a carrier having a small number of allocated bits signifies a carrier to which three bits have been allocated.

After the power of each carrier is increased or decreased, the number of allocated bits of each carrier is calculated in accordance with Equation (1) and the sum total b_sum of numbers of bits obtained when the decimal parts of the bit counts are discarded is calculated (step 606). This is illustrated by the combinations of arrows and black dots in FIG. 7. The powers of carriers #10 to #11 are increased by Δx each (for a total increase of 2·Δx), and the powers of carriers #6, #7 are decreased correspondingly by Δx each. It should be noted that it will suffice if the total power reduction is 2·Δx, e.g., the power of either carrier #6 or #7 may be decreased by 2·Δx instead of decreasing the powers of each of carriers #6, #7 by Δx. In the case of FIG. 7, the number of bits allocated to each carrier becomes as shown in FIG. 8, and b_sum is equal to 37.

Next, the total bit count b_base obtained by the known method and the total allocated bit count b sum after the power increase/decrease are compared in terms of magnitude (step 607). If b_sum>b_base holds or k=0 holds, second bit allocation processing of the present invention is exited (step 608). That is, the bit/gain allocation unit 332 creates an allocation table, which includes the number B of bits allocated to each carrier and the additional gain G of each carrier, stores this table in the allocation-table storage unit 333 and then sends the table to the office side from the transmitting section 310.

If it is found that b_sum≦b_base holds (“NO” at step 607), k is reduced (step 609) and then the processing from step 603 onward is repeated. Then b_sum is obtained again and processing continues until a “YES” decision is rendered at step 607. It should be noted that even in a case where a “YES” decision is rendered at step 607 of FIG. 6 and processing would ordinarily be exited, the number k of carriers of interest may be reduced if desired to search for the optimum bit allocation.

Thus, in accordance with the second bit allocation method of the present invention, the total number of transmit bits allocated to the carriers can be increased without raising total transmission power, thereby making it possible to improve the transmission capability of a multicarrier transmission apparatus.

The present invention as set forth above is applied to a case where the transmission capability of a multicarrier transmission apparatus is to be improved. However, the invention can be applied also to bit allocation processing (FIG. 5) carried out at training of a subscriber line transmission system.

(D) Third Allocation Method

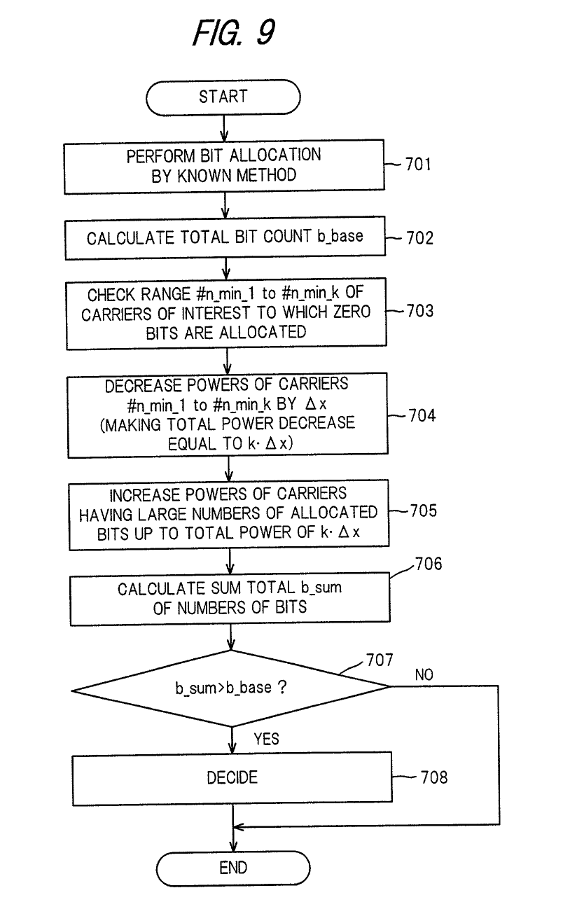

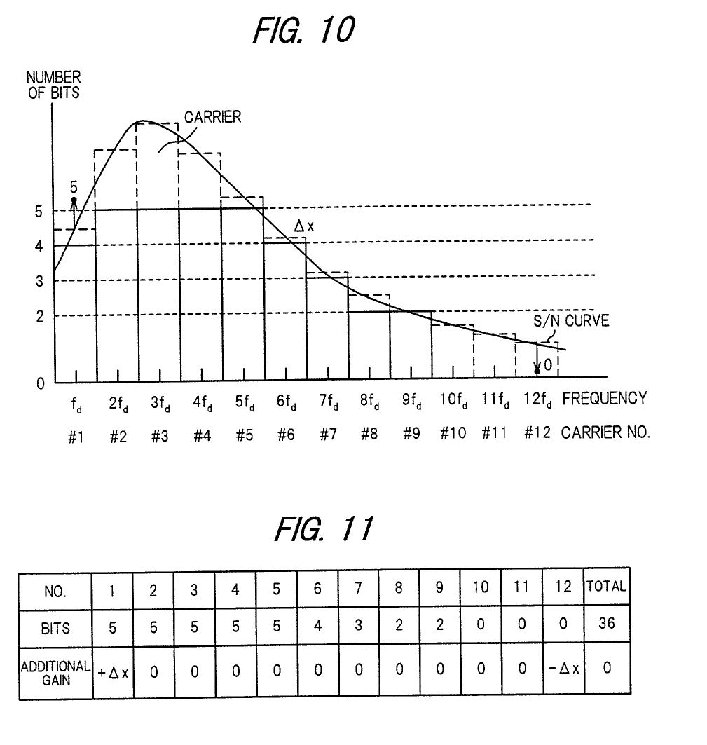

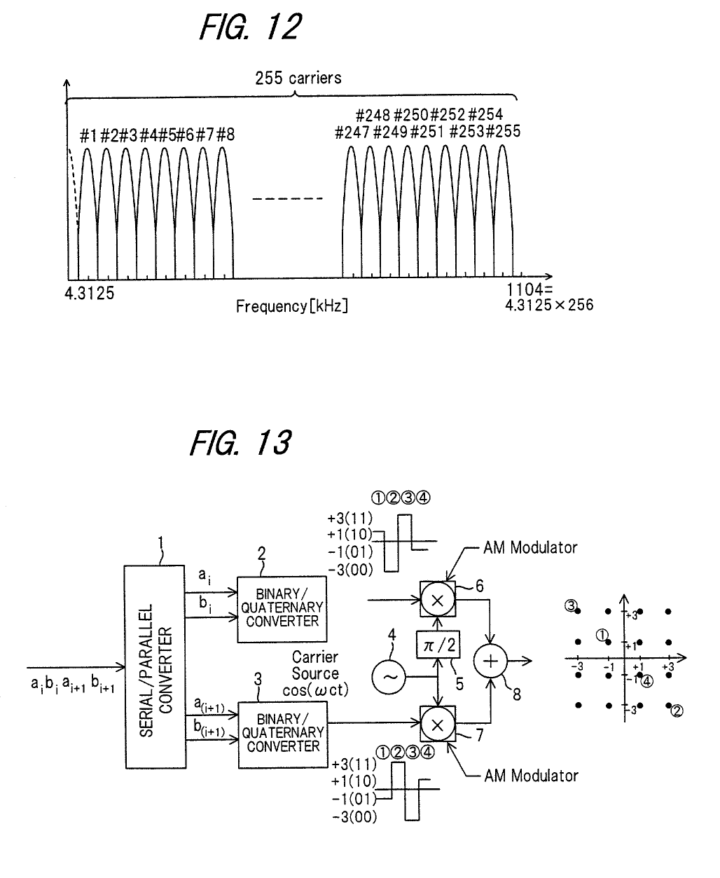

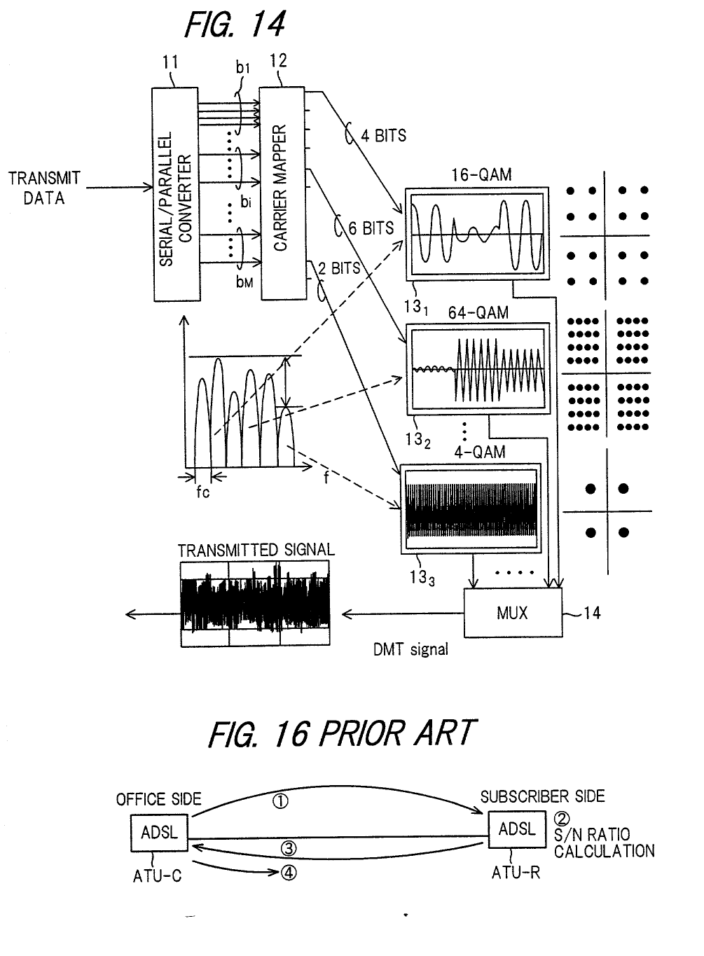

FIG. 9 shows the algorithm of a third bit allocation method implemented by the receive B&G controller 330 according to the present invention, and FIG. 10 is a diagram useful in describing the third bit allocation method.

First, bit allocation based upon a well-known method is carried out (step 701) and then the total bit count b_base, namely the total number of bits, that has been allocated to all carriers is calculated (step 702). The example of FIG. 10 is similar to that of the example of FIG. 3 and the details thereof need not be described again. The result of this processing is that bits are allocated to each of the carriers #1 to #12 and b_base becomes equal to 35, as illustrated in FIG. 17.

When the calculation of total bit count b_base at step 702 is completed, the range #n_min_{—}1 to #n_min_k of carriers of interest to which zero bits are allocated is checked (step 703).

A carrier of interest to which no bits are allocated is a carrier, among carriers for which the bit allocation is zero, for which there is a little likelihood that a bit will be allocated anew even if power is increased. In actuality, among carriers to which zero bits are allocated, carriers belonging to the high-frequency side often constitute the carrier range of interest, as illustrated in FIG. 10. In FIG. 10, carrier #12 on the high-frequency side is the carrier of interest among carriers to which zero bits are allocated. In this case, k=1 holds.

Next, the powers of the carriers #n_min_{—}1 to #n_min_k (carrier #12) are decreased by Δx (for a total power decrease of k·Δx) (step 704), and the powers of carriers having numbers of allocated bits that are as large as possible, which carriers are other than the carriers #n_min_{—}1 to #n_min_k (carrier #12), are increased up to a total power of k·Δx (step 705). It is assumed here that the carriers for which power is increased do not include carriers for which the number of allocated bits is equal to the maximum limit number. The reason for this is that even if the gain of a carrier for which the number of allocated bits is equal to the maximum limit number is increased, the number of allocated bits does not increase. Accordingly, a carrier whose power is increased in one whose number of allocated bits if four in the case of FIG. 10.

After the power of each carrier is increased or decreased, the number of allocated bits of each carrier is calculated in accordance with Equation (1) and the sum total b_sum of numbers of bits obtained when the decimal parts of the bit counts are discarded is calculated (step 706). This is illustrated by the combinations of arrows and black dots in FIG. 10. The power of carrier #12 is decreased by Δx, and the power of carrier #1 is increased correspondingly by Δx. It should be noted that instead of increasing the power of carrier #1 by Δx, power may be increased by a total of Δx by splitting the power increase among two or more carriers. In the case of FIG. 10, the number of bits allocated to each carrier becomes as shown in FIG. 11, and b_sum is equal to 36.

Next, the total bit count b_base obtained by the known method and the total allocated bit count b_sum after the power increase/decrease are compared in terms of magnitude (step 707). If b_sum>b_base holds, third bit allocation processing of the present invention is exited (step 708). That is, the bit/gain allocation unit 332 creates an allocation table, which includes the number B of bits allocated to each carrier and the additional gain G of each carrier, stores this table in the allocation-table storage unit 333 and then sends the table to the office side from the transmitting section 310.

If it is found that b_sum≦b_base holds (“NO” at step 707), processing is exited. This is because there is no change in result even if the range of the number k of carriers of interest is narrowed.

Thus, in accordance with the third bit allocation method of the present invention, the total number of transmit bits allocated to the carriers can be increased without raising total transmission power, thereby making it possible to improve the transmission capability of a multicarrier transmission apparatus.

The present invention as set forth above is applied to a case where the transmission capability of a multicarrier transmission apparatus is to be improved. However, the invention can be applied also to bit allocation processing (FIG. 5) carried out at training of a subscriber line transmission system.

In the case described above, the first to third bit allocation algorithms of the present invention are used independently of one another. However, these algorithms can be used in combination.

Thus, in accordance with the present invention, (1) the S/N ratio of each carrier is measured and a number of transmit bits is allocated to each carrier based upon the S/N ratio; (2) subsequently the gains of carriers for which the number of allocated bits is equal to a maximum limit number are decreased and the gains of prescribed carriers other than these carriers are increased; and (3) control is exercised in such a manner that the sum total of gain increases and sum total of gain decreases will be equal. As a result, the total number of transmit bits allocated to the carriers can be increased without raising transmission power, thereby making it possible to improve the transmission capability of a multicarrier transmission apparatus. In this case, a carrier for which gain is increased is made a carrier for which the number of allocated bits is large. The result is that the total number of allocated bits can be increased.

Further, in accordance with the present invention, (1) the S/N ratio of each carrier is measured and a number of transmit bits is allocated to each carrier based upon the SIN ratio; (2) the gains of carriers, among carriers to which bits have not been allocated, for which there is a high likelihood that bits will be allocated anew if the gains thereof are increased, are increased, and the gains of prescribed carriers other than these carriers are decreased; and (3) control is exercised in such a manner that the sum total of gain increases and sum total of gain decreases will be equal. As a result, the total number of transmit bits allocated to the carriers can be increased without raising transmission power, thereby making it possible to improve the transmission capability of a multicarrier transmission apparatus. In this case, a carrier for which gain is decreased is made a carrier for which the number of allocated bits is small but other than two. The result is that the total number of allocated bits can be increased.

Further, in accordance with the present invention, (1) the S/N ratio of each carrier is measured and a number of transmit bits is allocated to each carrier based upon the S/N ratio; (2) the gains of carriers, among carriers to which bits have not been allocated, for which there is little likelihood that bits will be allocated anew even if the gains thereof are increased, are decreased, and the gains of prescribed carriers other than these carriers are increased; and (3) control is exercised in such a manner that the sum total of gain increases and sum total of gain decreases will be equal. As a result, the total number of transmit bits allocated to the carriers can be increased without raising transmission power, thereby making it possible to improve the transmission capability of a multicarrier transmission apparatus. In this case, a carrier for which gain is increased is a carrier other than a carrier for which the number of allocated bits is equal to the maximum limit number. The result is that the total number of allocated bits can be increased.

As many apparently widely different embodiments of the present invention can be made without departing from the spirit and scope thereof, it is to be understood that the invention is not limited to the specific embodiments thereof except as defined in the appended claims.

What is claimed is:

1. A bit allocation method for deciding number of transmit bits and gain allocated to each carrier in multicarrier transmission, comprising the steps of:
measuring S/N ratio of each carrier and allocating a number of transmit bits to each carrier based upon the S/N ratio;
subsequently decreasing the gains of carriers for which the number of allocated bits is equal to a maximum limit number and increasing the gains of prescribed carriers other than these carriers; and
performing control in such a manner that the sum total of gain increases and sum total of gain decreases will be equal, wherein the total of number of transmit bits allocated to the carriers is increased.

2. The method according to claim 1, wherein a carrier for which gain is increased is a carrier for which the number of allocated bits is large.

3. A bit allocation method for deciding number of transmit bits and gain allocated to each carrier in multicarrier transmission, comprising the steps of:
measuring S/N ratio of each carrier and allocating a number of transmit bits to each carrier based upon the S/N ratio;
subsequently increasing the gains of carriers, among carriers to which bits have not been allocated, for which there is a high likelihood that a bit will be allocated anew if the gains thereof are increased, and decreasing the gains of prescribed carriers other than these carriers; and
performing control in such a manner that the sum total of gain increases and sum total of gain decreases will be equal, wherein the total number of transmit bits allocated to the carriers is increased.

4. The method according to claim 3, wherein a carrier for which gain is decreased is a carrier for which the number of allocated bits is small but other than two.

5. A bit allocation method for deciding number of transmit bits and gain allocated to each carrier in multicarrier transmission, comprising the steps of:
measuring S/N ratio of each carrier and allocating a number of transmit bits to each carrier based upon the S/N ratio;
subsequently decreasing the gains of carriers, among carriers to which bits have not been allocated, for which there is little likelihood that a bit will be allocated anew even if the gains thereof are increased, and increasing the gains of prescribed carriers other than these carriers; and
performing control in such a manner that the sum total of gain increases and sum total of gain decreases will be equal, wherein the total number of transmit bits allocated to the carriers is increased.

6. The method according to claim 5, wherein a carrier for which gain is increased is a prescribed carrier other than a carrier for which the number of allocated bits is equal to the maximum limit number.

7. A bit allocation apparatus for deciding number of transmit bits and gain allocated to each carrier in multicarrier transmission, comprising:
an S/N ratio measurement unit for measuring S/N ratio of each carrier;
a control unit for allocating a number of transmit bits to each carrier based upon the S/N ratio, subsequently decreasing the gains of carriers for which the number of allocated bits is equal to a maximum limit number, increasing the gains of prescribed carriers other than these carriers, and performing control in such a manner that the sum total of gain increases and sum total of gain decreases will be equal, thereby deciding the number of bits and gain allocated to each carrier;
an allocation table for storing number of bits and gain that have been allocated to each carrier;
a transmitting unit for transmitting content of said allocation table to the side of a communicating party; and
a setting unit for setting the number of allocated bits and the gain of each carrier in a receiving unit which receives and demodulates data that is transmitted from the communicating party.

8. A bit allocation apparatus for deciding number of transmit bits and gain allocated to each carrier in multicarrier transmission, comprising:
an S/N ratio measurement unit for measuring S/N ratio of each carrier;
a control unit for allocating a number of transmit bits to each carrier based upon the S/N ratio, subsequently increasing the gains of carriers, among carriers to which bits have not been allocated, for which there is a high likelihood that a bit will be allocated anew if the gains thereof are increased, decreasing the gains of prescribed carriers other than these carriers, and performing control in such a manner that the sum total of gain increases and sum total of gain decreases will be equal, thereby deciding the number of bits and gain allocated to each carrier;
an allocation table for storing number of bits and gain that have been allocated to each carrier;
a transmitting unit for transmitting content of said allocation table to the side of a communicating party; and
a setting unit for setting the number of allocated bits and the gain of each carrier in a receiving unit which receives and demodulates data that is transmitted from the communicating party.

9. A bit allocation apparatus for deciding number of transmit bits and gain allocated to each carrier in multicarrier transmission, comprising:
an S/N ratio measurement unit for measuring S/N ratio of each carrier;
a control unit for allocating a number of transmit bits to each carrier based upon the S/N ratio, subsequently decreasing the gains of carriers, among carriers to which bits have not been allocated, for which there is little likelihood that a bit will be allocated anew if the gains thereof are increased, increasing the gains of prescribed carriers other than these carriers, and performing control in such a manner that the sum total of gain decreases and sum total of gain increases will be equal, thereby deciding the number of bits and gain allocated to each carrier;
an allocation table for storing number of bits and gain that have been allocated to each carrier;
a transmitting unit for transmitting content of said allocation table to the side of a communicating party; and
a setting unit for setting the number of allocated bits and the gain of each carrier in a receiving unit which receives and demodulates data that is transmitted from the communicating party.
